(19) United States
(12) Patent Application Publication
(10) Pub. No.: US 2003/0187832 A1
(43) Pub. Date: Oct. 2, 2003

(54) Method for locating patent-relevant web pages and search agent for use therein

(76) Inventor: Scot A. Reader, Sherman Oaks, CA (US)

Correspondence Address: Scot A. Reader, Esq., 3424 Woodcliff Road, Sherman Oaks, CA, 91403, US

(21) Appl. No.: 10/114,223

(22) Filed: Apr. 2, 2002

(51) Int. Cl. G06F 17/30

(52) U.S. Cl. 707/3

(57) ABSTRACT

The present invention provides a highly automated method for locating patent-relevant Web pages and a search agent for use therein. The search agent mediates between a search client, such as a Web browser, and a Web search server, such as a Web search engine query server, to increase automation in locating patent-relevant Web pages and improve the relevancy of located Web pages. The search agent receives patent identifiers from end-user systems, identifies patent data for the patent identifiers, shapes the patent data into search terms and submits the search terms to the Web search server. The Web search server identifies Web page locations relevant to the search terms and the Web page locations are returned to the end-user systems via the search agent.

### BACKGROUND OF THE INVENTION

It is difficult to overstate the importance of infringement and invalidity evidence in strategic patent decision-making, particularly in patent licensing. If there is evidence of infringement of a valid patent claim, a licensing target will place a high value on a license. Conversely, if there is scant or no evidence of infringement of a valid patent claim, a licensing target will place a low value on a license. Other factors come to bear on the licensing target's assessment of the value of a license, such as the licensing targets desire for design freedom. But evidence of infringement of at least one valid patent claim is often the critical factor in “sealing the deal.”

It is also difficult to overstate the importance of the Internet as a repository of infringement and invalidity evidence. There are more than two billion publicly available Web pages, with millions more added every day. Millions of these Web pages provide unique insight into products and services that may anticipate or infringe patents.

Despite the importance of infringement and invalidity evidence to strategic patent decision-making and the plethora of Web pages that may yield such evidence, few specialized Web tools have been developed to facilitate the extraction of such evidence. Use of the Internet by patent professionals for infringement/invalidity detection has remained largely limited to manually reducing a patent claim to keywords, transmitting a search query including the keywords to a general purpose Web search engine and reviewing a search result including locations of Web pages received from the Web search engine in response to the search query.

### SUMMARY OF THE INVENTION

The present invention provides a highly automated method for locating patent-relevant Web pages and a search agent for use therein. The search agent mediates between a search client, such as a general purpose Web browser, and a Web search server, such as a general purpose Web search engine query server, to increase automation in locating patent-relevant Web pages and improve the relevancy of located Web pages.

In one aspect of the invention, patent data and Web page data are stored in a network. The patent data are made accessible to the search agent and the Web page data are made accessible to the Web search server. The search client transmits a front-end query to the search agent including a patent identifier, a query instruction and a result instruction. The search agent determines patent data using the patent identifier, determines a search term and a domain identifier using the patent data and the query instruction and forms a back-end query including the search term and the domain identifier. The search agent transmits the back-end query to the Web search server. The Web search server determines the location of one or more Web pages using the search term and the domain identifier and forms a back-end result including the one or more Web page locations. The Web search server transmits the back-end result to the search agent. The search agent determines a front-end result using the backend result and the result instruction. The search agent transmits the front-end result to the search client.

In another aspect of the invention, the search agent applies a shaping function to patent data to determine the search term.

In another aspect of the invention, the shaping function includes determining a score for words associated with the patent data.

In another aspect of the invention, the shaping function includes determining a score for words associated with the patent data in function of the usage of the words in one or more context sources for the patent data.

In another aspect of the invention, the shaping function includes determining a score for words associated with the patent data in function of the relevancy of the context sources where the uses occur.

In another aspect of the invention, the context sources include one or more of the patent of which the patent data are a part, the patents backward citations and the patents forward citations.

In another aspect of the invention, the score determines the words' search term status.

In another aspect of the invention, the score determines whether the words are included in the search term.

In another aspect of the invention, the score determines whether the words are a mandatory element of the search term.

In another aspect of the invention, the score determines whether the words are a recommended element of the search term.

In another aspect of the invention, the search agent applies a domain identifying function to determine the domain identifier.

In another aspect of the invention, the domain identifying function includes identifying patent classification data associated with the patent data.

These and other aspects of the present invention will be better understood by reference to the following detailed description, taken in conjunction with the accompanying drawings briefly described below. Of course, the actual scope of the invention is defined by the appended claims.

### BRIEF DESCRIPTION OF THE DRAWINGS

FIG. 1 is a schematic of a network architecture in which a preferred embodiment of the present invention is operative;

FIG. 2 is a functional diagram of a search agent operative in the network architecture according to FIG. 1; and

FIG. 3 is a flow diagram of a preferred highly automated method for locating patent-relevant Web pages within the network according to FIG. 1.

### DETAILED DESCRIPTION OF THE PREFERRED EMBODIMENT

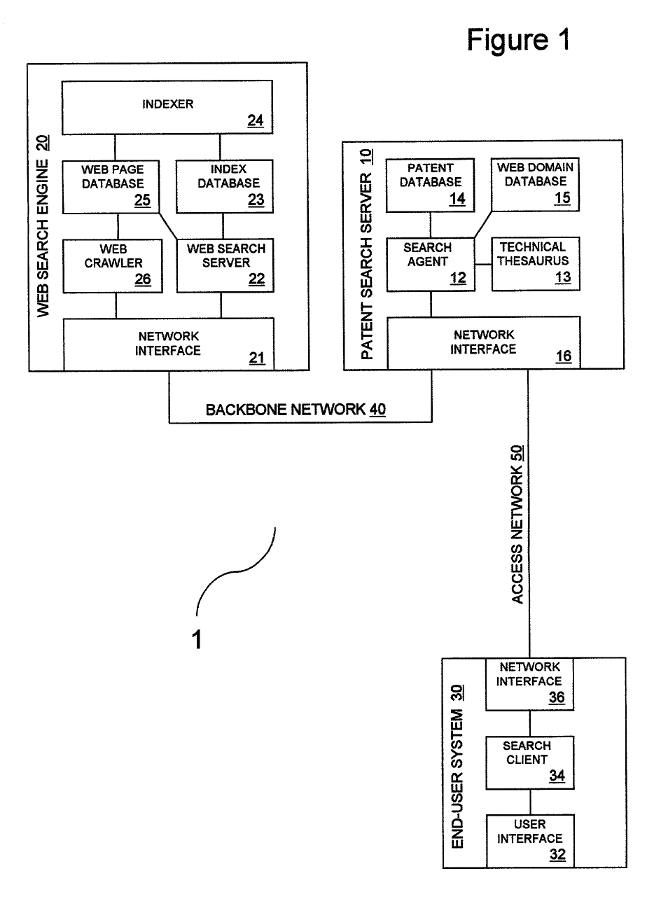

Referring to FIG. 1, a network architecture 1 in which a preferred embodiment of the present invention is operative is shown. Architecture 1 includes a patent search server 10, a Web search engine 20 and an end-user system 30. Patent search server 10 and Web search engine 20 are interconnected over a backbone network 40. Patent search server 10 and end-user system 30 are interconnected over an access network 50. Physical layer connectivity between patent search server 10, Web search server 20 and end-user system 30 may be wired or wireless or some combination thereof and may be include an arbitrary number of intermediate hops which are not shown. Data link and network layer connectivity between patent search server 10, Web search server 20 and end-user system 30 may utilize one or more local area network and wide area network data communication protocols such as Ethernet, Token Ring, Fiber Distributed Data Interface, Asynchronous Transfer Mode, Frame Relay, Multiprotocol Label Switching, Internet Protocol (IP) and Internet Packet Exchange. Patent search server 10, Web search server 20 and end-user system 30 preferably locate one another using Domain Name Services (DNS) and IP addressing. End-user system 30 may be a desktop computer, notebook computer, cell phone, personal data assistant, workstation or other Web-enabled system. Although architecture 1 is illustrated to include three interconnected nodes, namely, patent search server 10, Web search engine 20 and end-user system 30, it will be appreciated that each of these three nodes may be interconnected to an arbitrary number of other nodes which are not shown.

End-user system 30 includes a user interface 32, a search client 34 and a network interface 36. User interface 32 is a display for viewing textual and graphical information including search results. Search client 34 is a microprocessor-driven software application, such as a general purpose Web browser, for facilitating information exchange between end-user system 30 and other nodes and for facilitating information viewing on user interface 32. Facilitation of information exchange includes accepting search requests, generating search queries from search requests, transmitting search queries and receiving search results. Accepting search requests includes accepting search information on user interface 32. Generating search queries includes generating from search information accepted on user interface 32 Uniform Resource Identifiers (URIs), as defined in Internet Engineering Task Force (IETF) Request for Comment (RFC) 2616, and encapsulating URIs in Hypertext Transfer Protocol (HTTP) GET requests, as defined in IETF RFC 2396. Transmitting search queries includes transmitting HTTP GET requests. Receiving search results includes accepting result information from network interface 36. Facilitation of information viewing includes facilitating display of result information on user interface 32. Network interface 36 is an application specific integrated circuit (ASIC)-based physical, data link and network layer device for transmitting, receiving and formatting information exchanged between end-user system 30 and other nodes.

Web search engine 20 includes network interface 21, Web search server 22, index database 23, indexer 24, Web page database 25 and Web crawler 26. Network interface 21 is an ASIC-based physical, data link and network layer device for transmitting, receiving and formatting information exchanged between Web search engine 20 and querying nodes. Web search server 22 is a microprocessor-driven software application for resolving search queries to search results. Resolving a search query to a search result includes extracting a URI including a search term from an HTTP GET request received from a querying node, performing a “look up” operation in index database 23 to identify Web pages matching the search term, retrieving the Web pages from Web page database 25, ranking the Web pages by relevancy, formatting the Web pages into a search result in a Hypertext Markup Language (HTML) or Extensible Markup Language (XML) format and returning the search result to the querying node. Matching of a search term and a Web page may be defined in relation to, for example, inclusion in the Web page of all mandatory elements of the search Is term. Relevancy of a Web page may be defined in relation to, for example, the inclusion in the Web page of mandatory and recommended elements of the search term. Index database 23 includes one or more data stores having wordto-Web page associations. Web crawler 26 is a microprocessor-based software application that visits Web servers hosting websites, extracts Web pages therefrom, and stores the Web pages in Web page database 25. Indexer 24 adds to index database 23 word-to-Web page associations for Web pages stored in Web page database 25.

Patent search server 10 includes network interface 16, search agent 12, patent database 14, technical thesaurus 13 and Web domain database 15. Patent database 14 includes one or more data stores having full-text patents. Technical thesaurus 13 includes one or more data stores having groups of words related by meaning. Web domain database 15 includes one or more data stores having class-to-Web domain associations for patent classifications, wherein the Web domains are rank-ordered within the associations by relevancy to the class. Search agent 12 is a microprocessor-driven software application interfacing with search client 34 over access network 50, with Web search server 22 over backbone network 40, and locally with patent database 14, technical thesaurus 13 and Web domain database 15. Search agent 12, through judicious accesses of patent database 14, technical thesaurus 13 and Web domain database 15 and intelligent manipulation of data retrieved from such accesses, mediates between search client 34 and Web search server 22 to increase automation in locating patent-relevant Web pages and improve the relevancy of located Web pages. Mediation between search client 34 and Web search server 22 includes receiving by search agent 12 of a front-end query (e.g. first HTTP GET request) from end-user system 30 having a patent identifier, a query instruction and a result instruction (e.g. in a URI); performing a “look up” operation in patent database 14 to retrieve patent data associated with the patent identifier; shaping the patent data into a search term using the patent data and the query instruction, including performing “look up” operations in technical thesaurus 13 and Web domain database 15; resolving a domain identifier using the patent data and the query instruction; forming a back-end query (e.g. second HTTP GET request) including the search term and the domain identifier (e.g. in a URI); and transmitting the back-end query to Web search server 22. Mediation further includes receiving a back-end result from Web search server 22, forming a frontend result using the back-end result and the result instruction and transmitting the front-end result to the search client 34. Network interface 16 is an application specific integrated circuit (ASIC)-based physical, data link and network layer device for transmitting, receiving and formatting information exchanged between patent search server 10 and other nodes.

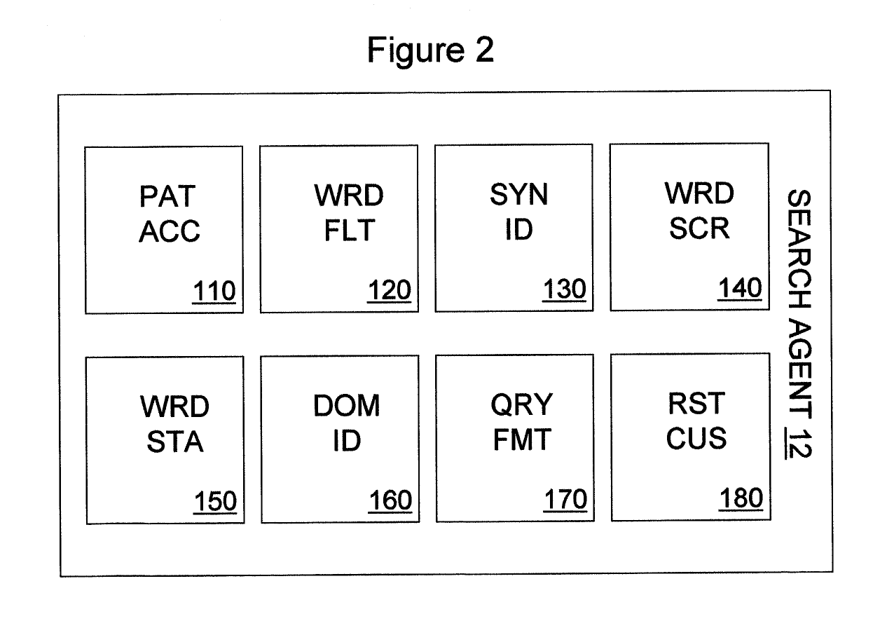

A functional diagram of search agent 12 is shown in FIG. 2. Agent 12 performs a patent data access (PAT ACC) function 110. PAT ACC 110 serves, after receiving the front-end query from end-user system 30, to extract the patent identifier, perform a “look up” operation in patent database 14 using the patent identifier and retrieve patent data associated with the patent identifier. The patent identifier preferably includes a patent number and a patent claim number. The patent data preferably include patent claim text corresponding to the patent number and the patent claim number and a patent classification corresponding to the patent number.

Agent 12 also performs a word filtering (WRD FLT) function 120. WRD FLT 120 serves, after retrieval of the patent data associated with the patent identifier, to eliminate low value words from the patent data. Low value words include words which, if included in a search term, would tend to reduce the relevancy of search results. Low value words include, by way of example, articles, conjunctions, prepositions and terms of art in patent claim drafting. WRD FLT 120 preferably includes “looking up” the words of the patent claim text in a preconfigured search control list and eliminating from the patent claim text words found in the list.

Agent 12 also performs a synonym identification (SYN ID) function 130. SYN ID 130 serves, after elimination of low value words from the patent data, to identify synonyms for the remaining words in the patent data and assemble the remaining words and their synonyms into word “bundles”. SYN ID 130 preferably includes “looking up” the remaining words of the patent claim text in technical thesaurus 13 and grouping words associated therein.

Agent 12 also performs a word scoring (WRD SCR) function 140. WRD SCR 140 serves, after grouping the remaining words of the patent data into word bundles, to score the word bundles. To score the word bundles, WRD SCR 140 employs a weighted voting scheme which tabulates a vote count for each word bundle based on the number of uses of words in the bundle in context sources for the patent data and the relevancy of the context sources where the uses occur. Each use of a word in a bundle in a context source is counted as one or more “votes” for the word bundle, with the number of votes depending on the relevancy of the context source that uses the word. Context sources include, for example, the claims of the subject patent (i.e. the patent from which the patent data were retrieved), the abstract of the subject patent, the specification of the subject patent, the claims, abstracts and specifications of the subject patent's backward patent citations and the claims, abstracts and specifications of the subject patent's forward patent citations. Backward patent citations are patents cited as references by the subject patent. Forward patent citations are patents that cite the subject patent as a reference. Preferably, each context source is assigned a weight. Purely by way of example, each claim set (e.g. each independent claim and claims dependent thereon) of the subject patent may be assigned a weight of 20 divided by the number of claim sets, the abstract of the subject patent may be assigned a weight of 20, the specification of the subject patent may be assigned a weight of 2, each claim set of a backward citation may be assigned a weight of 10 divided by the number of claim sets and backward citations, the abstract of each backward citation may be assigned a weight of 10 divided by the number of backward citations, the specification of each backward citation may be assigned a weight of 1 divided by the number of backward citations, each claim set of a forward citation may be assigned a weight of 10 divided by the number of claim sets and forward citations, the abstract of each forward citation may be assigned a weight of 10 divided by the number of forward citations and the specification of each forward citation may be assigned a weight of 1 divided by the number of forward citations.

Agent 12 also performs a word status (WRD STA) function 150. WRD STA 150 serves, after scoring the word bundles, to determine their status with respect to the search term. WRD STA 150 translates each word bundle's vote count into a percentile relative to the other word bundles [e.g. the word bundle having the Xth highest vote count among 100 word bundles translates into the (100−Xth) percentile] and compares each word bundle's percentile with a series of percentage thresholds to determine the word bundle's search term status. Word bundles whose percentile meets or exceeds a first percentage threshold are included in the search term and are identified as mandatory. Word bundles whose percentile does not meet or exceed the first percentage threshold but meets or exceeds a second percentage threshold are included in the search term and are identified as recommended. Word bundles whose percentile does not meet or exceed the second percentage threshold are excluded from the search term. The percentage thresholds are preferably specified in the query instruction. Purely by way of example, word bundles whose percentile is greater than or equal to 75 may be included in the search term and identified as mandatory. Word bundles whose percentile is between 25 and 75 may be included in the search term and identified as recommended. Word bundles whose percentile is below 25 may be excluded from the search term. Identification of a word bundle as mandatory indicates to Web search server 22 that a Web page location must include at least one word in the bundle to be included in the search result. Identification of a word bundle as recommended indicates to the Web search server 22 to give an increased ranking to a Web page location included in the search result if it includes at least one word in the bundle.

Agent 12 also performs a domain identification (DMN ID) function 160. DMN ID 160 serves to determine a domain identifier. The domain identifier indicates to the Web search server 22 the Web domains from which matching Web page locations, if found, are to be returned. Inclusion of a Web domain in the domain identifier indicates to return matching Web page locations from the Web domain. Exclusion of a Web domain from the domain identifier indicates to not return matching Web page locations from the Web domain. The domain identifier is preferably determined using the query instruction, which specifies one of “all”, “top X high potential” (where X is a positive integer) or “www.Y” (where Y is a Uniform Resource Locator). If the query instruction specifies “all”, the domain identifier indicates to return Web page locations from all Web domains. If the query instruction specifies “www.Y”, the domain identifier indicates to return Web page locations from only from Web domain Y. If the query instruction specifies “top X high potential”, the domain identifier indicates to return Web page locations from the top X Web domains determined by DMN ID 160 as follows: retrieve a patent classification for the subject patent, “look up” the patent classification in Web domain database 15 and include the top X Web domains associated with the patent classification.

Agent 12 also performs a query formatting (QRY FMT) function 170. QRY FMT 170 serves, after determining the status of word bundles with respect to the search term and the domain identifier, to form a back-end query including the search term, the word status identifications (e.g. mandatory or recommended) and the domain identifier. QRY FMT 170 includes resolving the search term, word status identifications and domain identifier to a URI using query syntax specified for Web search server 22, encapsulating the URIs in an HTTP GET request and transmitting the HTTP GET request to Web search server 22.

Agent 12 also performs a result customization (RST CUS) function 180. RST CUS 180 serves, after receiving a back-end result in a standard HTML or XML display format from Web search server 22, to generate in accordance with the result instruction a front-end result for display by search client 34 and transmit the front-end result to search client 34. The result instruction may include, for example, an instruction to display or not display the subject patent or the patent claim text in the front-end result or a formatting instruction for displaying the Web page locations returned in the front-end result.

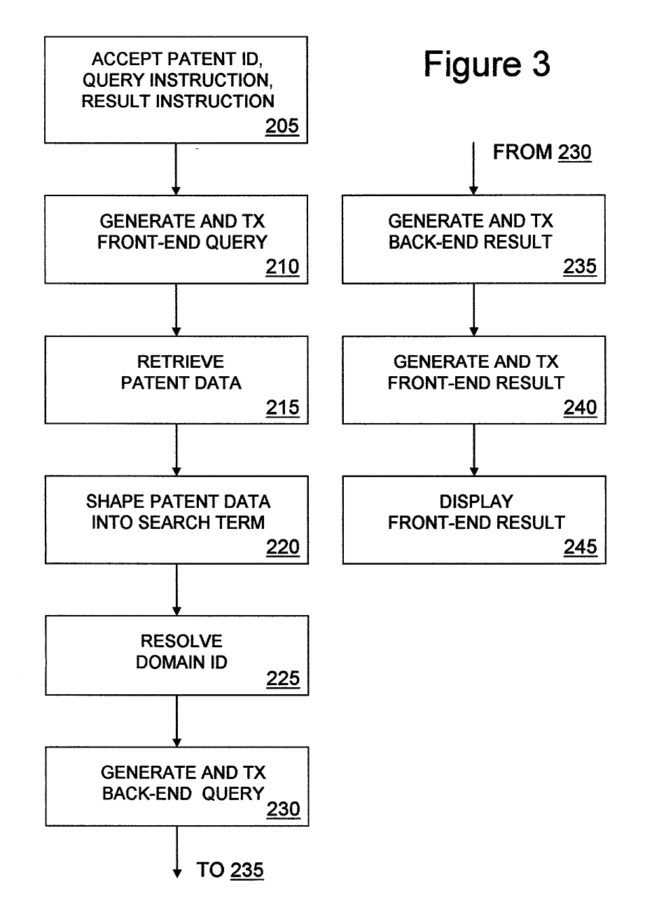

Turning finally to FIG. 3, a flow diagram illustrates a preferred method for implementing the present invention within network architecture 1. On end-user system 30, search client 34 accepts a patent identifier, a query instruction and a result instruction (205). Patent identifier, query instruction and result instruction may be “keyed in” on user interface 32 or may be implicit in mouse click selections made on user interface 32. Search client 34 generates a front-end query including the patent identifier, query instruction and result instruction and transmits the front-end query to patent search server 10 (210). On patent search server 10, search agent 34 performs a patent data access (PAT ACC) function 110 and retrieves patent data associated with the patent identifier (215). Search agent 34 applies a shaping function to the patent data in accordance with the query instruction, including a word filtering (WRD FLT) function 120, a synonym identification (SYN ID) function 130, a word scoring (WRD SCR) function 140 and a word status (WRD STA) function 150 to generate a search term (220). Search agent 34 performs a domain identification (DMN ID) function 160 in accordance with the query instruction to resolve a domain identifier (225). Search agent 34 performs a query formatting (QRY FMT) function 170 and forms a back-end query including the search term, the word status identifications (e.g. mandatory or recommended) and the domain identifier and transmits the back-end query to Web search engine 20 (230). On Web search engine 20, Web search server 22 resolves the back-end query to a back-end result including Web page locations relevant to the back-end query and transmits the back-end result to patent search server 10 (235). On patent search server 10, search agent 34 performs a result customization (RES CUS) function 180 to generate a front-end result in accordance with the result instruction for display by search client 34 and transmits the front-end result to end-user station 30 (240). On end-user station 30, search client 34 facilitates display of the front-end result on user interface 32 (245).

It will be appreciated by those of ordinary skill in the art that the invention can be embodied in other specific forms without departing from the spirit or essential character hereof. The present invention is therefore considered in all respects to be illustrative and not restrictive. The scope of the invention is indicated by the appended claims, and all changes that come within the meaning and range of equivalents thereof are intended to be embraced therein.

What is claimed is:

1. A method for locating a Web page for a patent, comprising:
determining a score for one or more words associated with patent data;
applying the score to determine a search term; and
applying the search term to determine a Web page location.

2. The method of claim 1, wherein the score is determined in function of usage of the words in one or more context sources for the patent data.

3. The method of claim 1, wherein the score is determined in function of relevancy of one or more context sources for the patent data in which the words are used.

4. The method of claim 2, wherein the context sources include a patent of which the patent data are a part.

5. The method of claim 2, wherein the context sources include a backward citation for a patent of which the patent data are a part.

6. The method of claim 2, wherein the context sources include a forward citation for a patent of which the patent data are a part.

7. The method of claim 1, wherein the score determines whether the words are included in the search term.

8. The method of claim 1, wherein the score determines whether the words are a mandatory element of the search term.

9. The method of claim 1, wherein the score determines whether the words are a recommended element of the search term.

10. The method of claim 1, wherein the patent data include patent claim text.

11. A method for locating a Web page for a patent, comprising:
transmitting a patent identifier from an end-user system;
applying the patent identifier to determine patent data;
applying the patent data to determine a search term;
applying the search term to determine a Web page location; and
transmitting the Web page location to the end-user system.

12. The method of claim 11, wherein the patent data include patent claim text.

13. The method of claim 11, further comprising the steps of:
applying the patent data to determine a Web domain; and
applying the Web domain to determine the Web page location.

14. The method of claim 13, wherein the patent data further include patent classification data.

15. A method for determining a search term, comprising:
determining a score for one or more words in function of usage of the words in one or more context sources; and
applying the score to determine a status of the words with respect to a search term.

16. The method of claim 16, wherein the score is determined in further function of relevancy of the context sources where the words are used.

17. The method of claim 15, wherein the score determines whether the words are included in the search term.

18. The method of claim 15, wherein the score determines whether the words are a mandatory element of the search term.

19. The method of claim 15, wherein the score determines whether the words are a recommended element of the search term.

20. The method of claim 15, further comprising applying the search term to determine a Web page location.

21. A system for locating patent-relevant Web pages, comprising:
a search client;
a search agent; and
a Web search server,
wherein the search agent applies a patent identifier received from the search client to determine patent data, applies the patent data to determine a search term and transmits the search term to the Web search server, in response to which the Web search server applies the search term to determine a Web page location and transmits the Web page location to search agent, in response to which the search agent transmits the Web page location to the search client.

22. The system of claim 21, wherein the search agent applies a query instruction received from the search client to determine a domain identifier and transmits the domain identifier to the Web search server, in response to which the Web search server applies the domain identifier to further determine the Web page location.

23. The system of claim 21, wherein the search agent applies a result instruction received from the search client to the Web page location prior to transmitting the Web page location to the search client.

24. The system of claim 21, wherein the search client is a Web browser.

25. The system of claim 21, wherein the Web search server is a Web search engine query server.

26. The system of claim 21, wherein the search client, the search agent and the Web search server reside on a first, second and third network node, respectively.

27. The system of claim 21, wherein the patent data include patent claim text.

28. A search agent for locating a Web page for a patent, comprising:
a shaper for determining a search term for a patent claim; and
a formatter for determining a query including the search term.

29. The search agent of claim 28, wherein the query is in a syntax specified for a Web search server.
